(19) United States
(12) Patent Application Publication
(10) Pub. No.: US 2019/0114909 A1
(43) Pub. Date: Apr. 18, 2019

(54) Method and Apparatus for Identifying Congestion Bottlenecks

(71) Applicant: TomTom Traffic B.V., Amsterdam (NL)

(72) Inventors: Christian Halama, Amsterdam (NL); Stephen Curran, Amsterdam (NL); Tomas Coomans, Amsterdam (NL); Bob Randsdorp, Amsterdam (NL); Volodymyr Pavlyshyn, Amsterdam (NL)

(21) Appl. No.: 16/090,944

(22) PCT Filed: Apr. 5, 2017
(86) PCT No.: PCT/EP2017/058053

§ 371 Date: Oct. 3, 2018

Related U.S. Application Data
(60) Provisional application No. 62/318,747, filed on Apr. 5, 2016.

(51) Int. Cl. G08G 1/01; G08G 1/052

(52) U.S. Cl. CPC G08G 1/0133; G08G 1/052; G08G 1/0112; G08G 1/0141

(57) ABSTRACT

The present invention describes techniques for identifying congestion hotspots within a navigable network within a geographic area. The hotspots are identified by obtaining positional data relating to the movement of a plurality of devices with time along navigable elements represented by segments of an electronic map, and determining, using the positional data, delay data for at least one time period for each of a plurality of the segments, wherein the delay data for a segment comprises a delay value representative of a delay experienced due to congestion by the devices when traversing a navigable element or portion thereof represented by the segment during the respective time period.

### FIELD OF THE INVENTION

The present invention relates to methods and systems for identifying navigable elements of a network of navigable elements, or simply navigable network, along which traffic flow is regularly delayed, and thus form so-called congestion bottlenecks or hotspots.

### BACKGROUND TO THE INVENTION

Road users increasingly rely upon traffic information to inform them of any incidents, such as traffic jams, road works, road closures, etc., which may affect travel time on a journey, and to help plan travel. Such information may be provided to a user during navigation along a route via an in-car navigation device, such as a portable navigation device (PND) or integrated device, or may be provided as an input to an Advanced Driver Assistance System (ADAS). Traffic information may also be used for route planning, e.g. by a navigation device, before commencing a journey, or to recalculate a fastest route during a journey if conditions change on a route. The information has conventionally been based on messages sent over an FM radio network via the Traffic Message Channel (TMC), which may be received by navigation devices and conveyed to a user, or otherwise used, by an ADAS or navigation system. A typical TMC message would include information identifying a geographic location, type and direction of an incident according to certain standard codes. More recently other traffic information systems have been developed, which rely at least in part upon other sources of traffic information, such as so-called “probe” data obtained from mobile phones, PNDs and other devices having positioning capability located in vehicles, which can be used to identify locations and speeds of vehicles, and thus indicate traffic conditions.

The Applicant has realised that there are also benefits to road users and indeed owners and/or managers of road networks, such as road authorities and other professional operators, to be informed of areas of a road network that are commonly congestion (or traffic) bottlenecks or “hotspots”, i.e. localised disruptions of vehicular traffic that typically occur, in contrast to traffic jams, as a result of the design of the road network, such as, for example, the narrowing of a section of a road, badly timed traffic lights or other similar control signals, sharp curves, uphill sections, etc. Road users can, for example, choose to proactively avoid known congestion bottlenecks when planning a route along the road network, while road authorities can use the knowledge of where there are congestion bottlenecks to plan changes to the road network that might help alleviate the problem.

### SUMMARY OF THE INVENTION

In accordance with a first aspect of the invention there is provided a method of identifying congestion hotspots in a navigable network within a geographic area, each navigable element being represented by one or more segments of an electronic map, the electronic map comprising a plurality of segments representative of the navigable network, each segment being connected to at least one other segment, the method comprising:

obtaining positional data relating to the movement of a plurality of devices with time along navigable elements represented by segments of the electronic map;

determining, using the positional data, delay data for at least one time period associated with each of a plurality of the segments, wherein the delay data is representative of a delay experienced due to congestion by the devices when traversing the navigable element or portion thereof represented by the segment during the respective time period;

generating a plurality of clusters from at least the plurality of segments having delay data, wherein each cluster comprises a plurality of segments, and wherein each segment in a cluster is connected to at least one other segment in the cluster;

determining an aggregated delay value for each generated cluster, wherein the aggregated delay value for a cluster is obtained using delay data associated with segments in the cluster; and

identifying one or more of the plurality of clusters as congestion hotspots based on the aggregated delay values.

In a preferred embodiment, according to the first aspect, the congestion hotspots may thus be identified by generating a plurality of clusters from at least some of segments within the navigable network, and determining an aggregated delay value for each generated cluster using the delay data associated with segments in the cluster. Preferably, the aggregated delay value for a cluster is obtained by summing or otherwise combining, e.g. by averaging, or by setting the maximum delay value of the segments within a cluster to be the aggregated delay value for the cluster, delay data for the (e.g. each of the) segments in the cluster. The delay data for the segments is determined from positional data relating to the movement of a plurality of devices along the navigable network. Preferably, the aggregated delay value for a cluster is calculated using (e.g. by summing or otherwise) the delay data associated with each of the segments within the cluster. However, it is contemplated that the aggregated delay value may be calculated using delay data from only a subset of the segments within the cluster, e.g. the largest segments, or segments contributing the largest delay, etc. Thus, in general, the aggregated delay value for a cluster may be calculated by using (e.g. summing or otherwise combining) delay data of at least some of the segments within the cluster. The clusters may then be sorted according to their respective aggregated delay value, e.g. from high to low aggregated delay value, and the clusters having the highest aggregated delay values may be identified as congestion hotspots.

According to embodiments of the first aspect, the clusters may be generated by selecting an initial segment, and iteratively adding to the cluster all segments in the network that are connected to at least one segment in the cluster until the length of the navigable network covered by the cluster satisfies a defined threshold condition. The process thus generally works by expanding outwards in all directions from the initially selected segment, and at each step adding connected segments into the cluster. Preferably, in each iteration, all segments that are connected to a segment within the cluster are added into the cluster. That is, in an initial step, all of the segments connected to the initial segment are added into the cluster. In the next step, all of the segments that are connected to these segments (i.e. segments that are two degrees away from the initial segment) are then added into the cluster, and so on. This is repeated until the cluster meets the defined threshold condition. For example, the process may be repeated until the cluster reaches a desired size of about 1 km, although it will be appreciated that this threshold is only an example, and the threshold may be set as desired depending on the user's requirements and the topology of the network. The cluster generating process may be repeated for different initial segments in order to generate a plurality of clusters within the network. Although the initial segments may be selected according to any desired criteria, and for example, in embodiments, only segments that have associated delay data may be selected as initial segments, in preferred embodiments, the process is repeated for each segment within the navigable network such that a cluster is generated for each segment within the navigable network and there are as many clusters as there are segments. It will be appreciated that the clusters generated in this way will therefore generally overlap, i.e. share common segments with, neighbouring clusters.

It may generally be most useful to identify unique, i.e. non-overlapping, congestion hotspots. Thus, the method may comprise identifying a set of non-connected clusters as congestion hotspots. For instance, in embodiments, the method may comprise sorting the clusters according to their aggregated delay values, processing the clusters from high to low aggregated delay values and only identifying as congestion hotspots clusters that are not connected to a previously identified congestion hotspot. For example, the list of sorted clusters may be processed from high to low aggregated delay values by including a cluster in a results list only if the cluster is not connected to any clusters that are already included in the results list. The list may be processed until the results list includes a desired number, N, of clusters (where N is some desired integer number of hotspots to be identified), representing the N non-connected clusters having the highest aggregate delay values, and these N clusters may identified as congestion hotspots. The value of N may be set appropriately depending on the user's requirements and the topology of the network. By way of example, for a network representing a typical city, the value of N may be set at about 25 (although this figure is of course simply exemplary). It is also contemplated, in other less preferred embodiments, that only non-connected clusters may be generated; for instance, the selection of the initial segments may be performed such that only non-connected clusters are generated.

Alternatively, the congestion hotspots may be determined by identifying a subset of segments of an electronic map that form paths through the navigable network represented by the electronic having high delay; the delay being determined from positional data relating to the movement of a plurality of devices along the navigable network. This subset of segments are split into a number of different clusters, and, for each cluster, typically each possible path through the cluster is identified and ranked based on their usage, i.e. based on how often they are traversed. A congestion hotspot can then be determined for each cluster by selecting the top one or more paths from the ranking, i.e. those that are most travelled, such that the congestion hotspot can be thought of as being generated by combining short, overlapping paths of high delay that are frequently travelled. This method also allows congestion hotspots to be identified and is considered to be novel and inventive in its own right.

Thus, in accordance with a second aspect of the invention, there is provided a method of identifying congestion hotspots in a navigable network within a geographic area, each navigable element being represented by one or more segments of an electronic map, the electronic map comprising a plurality of segments representative of the navigable network, each segment being connected to at least one other segment, said method comprising:

obtaining positional data relating to the movement of a plurality of devices with time along navigable elements represented by segments of the electronic map;

determining, using the positional data, delay data for at least one time period for each of a plurality of the segments, wherein the delay data for a segment is representative of a delay experienced due to congestion by the devices when traversing the navigable element or portion thereof represented by the segment during the respective time period;

identifying, using the determined delay data, a subset of segments from the plurality of segments that form paths through the navigable network represented by the electronic map having high delay;

determining a plurality of clusters from the subset of segments, wherein each cluster comprises a plurality of segments, and wherein each segment in a cluster is connected to at least one other segment in the cluster; and

selecting, using the positional data, one or more paths though each cluster that are most frequently traversed by devices to determine a congestion hotspot for each of the clusters, wherein the congestion hotspot for a cluster comprises the selected one or more paths for the cluster.

According to the second aspect of the present invention, the determined delay data is used to identify a subset of segments from the plurality of segments of the electronic map that form paths through the navigable network represented by the electronic map having high delay.

In a first embodiment of the second aspect, the subset of segments is identified by first ranking the segments of the electronic map based on the associated delay data, so as to, for example, rank the segments from highest to lowest delay (as indicated by the delay data). An initial subset of segments having the highest delay can then be chosen, e.g. a predetermined number of segments and/or those segments having a delay above a predetermined value, and gaps between these segments bridged (these additional segments being added to the initial subset of segments) to identify the subset of segments that form paths through the navigable network having high delay. As will therefore be appreciated, each path comprises a plurality of connected segments.

The bridging of gaps between segments in the initial subset of segments preferably comprises determining minimum cost, e.g. shortest, paths between pairs of segments in the initial subset, e.g. using a route search algorithm that explores possible paths between segments and assigns a cost to each path using a predetermined cost function. The route search algorithm can be of any desired and suitable form, such as one based on Dijkstra's algorithm. Each of the minimum cost paths is preferably then assessed in terms of length and/or delay, and the segments forming a path added to the segments of the initial subset based on the results of this analysis. For example, if a path is too long, i.e. above a predetermined distance threshold, then the path is rejected. Additionally and/or alternatively, if a path has a low delay (based on the delay data for the segments forming the path), then the path is rejected. Any other additional or alternative checks can be used as desired to determine which paths are to be accepted, and the segments of which are to be added to the initial subset of segments.

Alternatively, in a second embodiment, rather than first identifying segments and then forming connections between segments, paths through the navigable network represented by the electronic map are identified having a certain length, e.g. 100 m (although this figure is simply exemplary), and these paths are ranked based on the delay data for the individual segments forming each path. The subset of segments that form paths through the navigable network can then be chosen as the paths having the highest associated delay (as indicated by the delay data for the path).

Once the subset of segments that form paths through the navigable network having high delay have been identified, then these segments are clustered. This clustering process identifies a plurality of clusters, wherein each cluster comprises a plurality of segments, and wherein each segment in a cluster is connected to at least one other segment in the cluster. In embodiments of the second aspect, the clustering is preferably performed by taking each segment from the subset of segments identified in the previous step, and determining if another segment in the subset is connected to the segment. If they are connected, then the respective segments are added to the same cluster.

In embodiments of the second aspect of the present invention one or more paths through each cluster are selected; the selected one or more paths being those that are seen to be most frequently traversed by devices from which positional data is obtained, such that, for each cluster, the most relevant paths are identified. These one or more selected paths for a cluster define a congestion hotspot. In preferred embodiments, a plurality of paths are selected for each cluster, such that the congestion hotspot is a set of typically overlapping paths that have high delay and are highly traversed.

In embodiments, the one or more paths through each cluster are selected by ranking, for each of the clusters, according to a relative number of times each path is traversed by devices (as determined from the positional data). The relative number of times a path is traversed can be determined using positional data for the particular time period, e.g. recurring time period, for which the cluster was generated. Alternatively, the relative number of times a path is traversed can be determined using all the obtained positional data, regardless of time period, since this may be a better reflection of the most relevant paths.

The present invention extends also to systems including means for carrying out a method in accordance with any of the aspects or embodiments of the invention described herein.

Accordingly, in accordance with a further aspect of the invention, there is provided a system for identifying congestion hotspots in a navigable network within a geographic area, each navigable element being represented by one or more segments of an electronic map, the electronic map comprising a plurality of segments representative of the navigable network, each segment being connected to at least one other segment, said system comprising:

means for obtaining positional data relating to the movement of a plurality of devices with time along navigable elements represented by segments of the electronic map;

means for determining, using the positional data, delay data for at least one time period associated with each of a plurality of the segments, wherein the delay data is representative of a delay experienced due to congestion by the devices when traversing the navigable element or portion thereof represented by the segment during the respective time period;

means for generating a plurality of clusters from at least the plurality of segments having delay data, wherein each cluster comprises a plurality of segments, and wherein each segment in a cluster is connected to at least one other segment in the cluster;

means for determining an aggregated delay value for each generated cluster, wherein the aggregated delay value for a cluster is obtained using delay data associated with segments in the cluster; and

means for identifying one or more of the plurality of clusters as congestion hotspots based on the aggregated delay values.

Further, and in accordance with a further aspect of the invention, there is provided a system for identifying congestion hotspots in a navigable network within a geographic area, each navigable element being represented by one or more segments of an electronic map, the electronic map comprising a plurality of segments representative of the navigable network, each segment being connected to at least one other segment, said system comprising:

means for obtaining positional data relating to the movement of a plurality of devices with time along navigable elements represented by segments of the electronic map;

means for determining, using the positional data, delay data for at least one time period for each of a plurality of the segments, wherein the delay data for a segment is representative of a delay experienced due to congestion by the devices when traversing the navigable element or portion thereof represented by the segment during the respective time period;

means for identifying, using the determined delay data, a subset of segments from the plurality of segments that form paths through the navigable network represented by the electronic map having high delay;

means for determining a plurality of clusters from the subset of segments, wherein each cluster comprises a plurality of segments, and wherein each segment in a cluster is connected to at least one other segment in the cluster; and

means for selecting, using the positional data, one or more paths though each cluster that are most frequently traversed by devices to determine a congestion hotspot for each of the clusters, wherein the congestion hotspot for a cluster comprises the selected one or more paths for the cluster.

It will be appreciated that any feature described by reference to the first or second aspect of the invention may equally be applied to embodiments in accordance with any of the other aspects of the invention and vice versa, at least to the extent that they are not mutually incompatible. Thus, if not explicitly stated herein, the system of the present invention may comprise means for carrying out any of the steps of the method described.

The means for carrying out any of the steps of the method according to any of the aspects or embodiments described herein may comprise a set of one or more processors configured, e.g. programmed with a set of computer readable instructions, for doing so. A given step may be carried out using the same or a different set of processors to any other step. Any given step may be carried out using a combination of sets of processors. The system may further comprise data storage means, such as computer memory, for storing, for example, the electronic map and/or the positional data used to identify the congestion hotspots. The methods of the present invention are, in preferred embodiments, implemented by a server. Thus, in embodiments, the system of the present invention comprises a server comprising the means for carrying out the various steps described, and the method steps described herein are carried out by a server.

The present invention in accordance with any of its aspects or embodiments generally involves identifying congestion hotspots (which can also be referred to as congestion bottlenecks), which are areas of a navigable network, such as a road network, within a geographic area, such as city, having frequent and significant delays to traffic flow. In preferred embodiments, the congestion hotspots are the areas of worst traffic congestion in the geographic area, e.g. city, as defined by causing the most significant delays to traffic. As will be discussed in more detail below, the congestion hotspots are typically determined for particular recurring time periods, such as for each day of the week (or each weekday and the weekend), for morning or afternoon peak periods of each day of the week ((or each weekday and the weekend), etc.

As will described further below, congestion hotspots have a number of uses for drivers, road authorities and other professionals, such as: highlighting areas to avoid in unfamiliar cities, such that drivers can avoid the worst delays; providing metrics to help traffic managers better understand the road performance behaviour; and providing supporting evidence for policy makers to allocate budget for infrastructure improvement to improve traffic flow.

The navigable network may comprise a road network, wherein each navigable element represents a road or a portion of a road. For example, a navigable element can represent a road between two adjacent intersections of the road network, or a navigable element may represent a portion of a road between two adjacent intersections of the road network. As will be appreciated, however, the navigable network is not limited to a road network, and may comprise, for example, a network of foot paths, cycle paths, rivers, etc. It should be noted that the term “segment” as used herein takes its usual meaning in the art. A segment of an electronic map is a navigable link that connects two points or nodes. While embodiments of the present invention are described with particular reference to road segments, it should be realised that the invention may also be applicable to other navigable segments, such as segments of a path, river, canal, cycle path, tow path, railway line, or the like. Thus, any reference to a “road segment” may be replaced by a reference to a “navigable segment” or any specific type or types of such segments.

The electronic map (or mathematical graph, as it is sometimes known), in its simplest form, is effectively a database containing data representative of nodes, most commonly representative of road intersections, and lines between those nodes representing the roads between those intersections. In more detailed digital maps, lines may be divided into segments defined by a start node and end node. These nodes may be “real” in that they represent a road intersection at which a minimum of 3 lines or segments intersect, or they may be “artificial” in that they are provided as anchors for segments not being defined at one or both ends by a real node to provide, among other things, shape information for a particular stretch of road or a means of identifying the position along a road at which some characteristic of that road changes, e.g. a speed limit. In practically all modern digital maps, nodes and segments are further defined by various attributes which are again represented by data in the database. For example, each node will typically have geographical coordinates to define its real-world position, e.g. latitude and longitude. Nodes will also typically have manoeuvre data associated therewith, which indicate whether it is possible, at an intersection, to move from one road to another; while the segments will also have associated attributes such as the maximum speed permitted, the lane size, number of lanes, whether there is a divider in-between, etc. The electronic map may also contain data representative of the names of the roads within the road network, e.g. for use in generating congestion hotspot names, as described further below.

The present invention involves obtaining positional data relating to the movement of a plurality of devices along navigable elements of a navigable network with respect to time. The step of obtaining the positional data relating to the movement of devices along a navigable element is carried out by reference to the electronic map data indicative of the segment representing the navigable element of the network. The method may involve a step of matching positional data relating to the movement of devices in a geographic region including the network of navigable elements to each segment of the electronic map that is being considered in accordance with the invention.

In some arrangements the step of obtaining the positional data may comprise accessing the data, i.e. the data being previously received and stored. The positional data is preferably historical data. In this context the word historic should be considered to indicate data that is not directly reflective of conditions on the segment at the present time or in the recent past (perhaps within roughly the last five, ten, fifteen or thirty minutes). Historic data may for example relate to events occurring days, weeks or even years in the past. For example, in embodiments, the positional data used to determine the congestion hotspots relates to the last three months, such that it is possible to see quarterly trends, changes, etc. in the identified hotspots and in the severity of such hotspots.

In some arrangements the method may comprise receiving the positional data from the devices. In embodiments in which the step of obtaining the data involves receiving the data from the devices, the method may further comprise storing the received positional data before proceeding to carry out the other steps of the present invention. The step of receiving the positional data need not take place at the same time or place as the other step or steps of the method.

As discussed above, the positional data may be collected from a plurality of devices, and relates to the movement of those devices with respect to time. Thus, the devices are mobile devices. The positional data is preferably associated with temporal data, e.g. a timestamp. The positional data may be used to provide a positional “trace” of the path taken by the device. The devices may be any mobile devices that are capable of providing the positional data and sufficient associated timing data for the purposes of the present invention. The device may be any device having position determining capability. For example, the device may comprise means for accessing and receiving information from Wi-Fi access points or cellular communication networks, such as a GSM device, and using this information to determine its location. In preferred embodiments, however, the device comprises a global navigation satellite systems (GNSS) receiver, such as a GPS receiver, for receiving satellite signals indicating the position of the receiver at a particular point in time, and which preferably receives updated position information at regular intervals. Such devices may include navigation devices, mobile telecommunications devices with positioning capability, position sensors, etc. Preferably the device is associated with a vehicle. In these embodiments the position of the device will correspond to the position of the vehicle. References to positional data obtained from devices associated with vehicles, may be replaced by a reference to positional data obtained from a vehicle, and references to the movement of a device or devices may be replaced by a reference to the movement of a vehicle, and vice versa, if not explicitly mentioned. The device may be integrated with the vehicle, or may be a separate device associated with the vehicle such as a portable navigation apparatus.

The positional data obtained from the plurality of devices is commonly known as “probe data”. Data obtained from devices associated with vehicles may be referred to as vehicle probe data. References to “probe data” herein should therefore be understood as being interchangeable with the term “positional data”, and the positional data may be referred to as probe data for brevity herein.

Of course, the positional data may be obtained from a combination of different devices, or a single type of device. However, the present invention is not limited to the use of positional data obtained from a particular type of device, or devices associated with a particular form of transport, e.g. vehicles, and probe data from devices associated with multiple forms of transport may equally be taken into account. Typically, any probe data indicative of the movement of a device with respect to time along a navigable element may be used.

The positional data is used to determine delay data for at least one time period, and preferably a plurality of time periods, for each of a plurality of segments. The time period, or each of the time periods, is preferably recurring time period, e.g. a time period that occurs on a weekly basis, such as morning (e.g. around 6 h-10 h) and afternoon (e.g. around 16 h-20 h) rush hours on each day of the week.

Preferably, delay data is determined for each segment in the network (e.g. within a city). However, it will be appreciated that it may not be possible to determine delay data for every segment, e.g. where insufficient positional data is available. In that case, the methods described herein may be performed only for the segments where there is sufficient available positional and/or delay data. Preferably, however, where there is no (or not enough) positional or delay data available for a segment, the delay for that segment may be set to a desired value, such as zero, so that the segment may still be used e.g. within an algorithm for generating a cluster and/or determining an aggregated delay value.

The delay data for a segment is generally data that is representative of a delay experienced due to congestion when traversing the navigable element or portion thereof represented by the segment during the respective time period, and may, for instance, comprise a delay value representative of this delay. The delay data (i.e. delay value), may be representative of an average delay experienced by users when traversing the navigable element. However, in preferred embodiments, the delay data for a segment is representative of an accumulated delay for that segment, which takes into account the number of devices that traversed the navigable element to provide the positional data for the time period, and may e.g. be determined by multiplying the average delay by the number of devices, or a weighting factor indicative of the number of devices, that traversed the segment. The accumulated delay is typically preferred to the average delay as it has been found that the accumulated delay adds more weight to delays on important or major roads as opposed to smaller roads. However, regardless of whether the delay data is indicative of an average delay or an accumulated delay, in preferred embodiments, the delay data for a segment is determined per unit length, such that the delay for a segment is not influenced by the length of the segment. Accordingly, in embodiments, the delay data is representative of an average delay per unit length or an accumulated delay per unit length.

In embodiments, the delay data for a segment, and preferably for each segment, is determined using an average speed of travel and a free flow speed for the segment, optionally together with the length of the segment and/or the number of devices providing the positional data for the segment, as needed. As will be appreciated, due to the known relation between speed, distance and time, through knowledge of the length of a segment, the average speed for the segment and the free flow speed for the segment, then it is possible to determine an average time for which vehicles are delayed due to congestion for a segment.

The average speed of travel for a segment for a given, preferably recurring, time period, is preferably determined using the positional data and is indicative of an average speed of travel of devices, e.g. vehicles, along the navigable element or portion thereof represented by the segment in the time period. As discussed above, the positional data for a segment preferably comprises a sequence of time stamped positions indicative of the movements of a plurality of different devices. The sequence of positions for a single device can be used to determine an average speed at which that device traverses the navigable element. An average speed of travel for a segment is therefore preferably determined by applying an appropriate calculation technique to the average traversal speeds determined from a plurality of devices.

The free flow speed for a segment is indicative of a speed, e.g. an average speed, of travel of devices, e.g. vehicles, along the navigable element or portion thereof represented by the segment during a period of time in which there is no or substantially little traffic. This period may for example be one or more night-time hours where the attainable speed may be less influenced by other users. Such free-flow speeds will still reflect the influence of speed limits, road layout and traffic management infrastructure for example. In embodiments data indicative of the free flow speed is associated, in the digital map data, with data indicative of the navigable segment representing the navigable element to which it relates. In embodiments in which the navigable elements are represented by segments of a digital map, data indicative of a free flow speed may be associated with each segment. The method may extend to the step of obtaining the free flow speed for a segment using the positional data for the segment. The step of obtaining the free flow speed for an element or segment may comprise analysing positional data relating to the movement of devices that traversed the navigable element or portion thereof represented by the segment within a given predetermined time period. The relevant data may be obtained by suitable filtering of the positional data by reference to time. In order to be able to obtain a free flow speed, the predetermined time period should be chosen appropriately so that it will include data relating to movements which are representative of movements made under free-flow conditions. Typically the time period will be relatively long, such as a 24 hour period, or longer. For example, a week long period, or even a month or longer period might be considered, if free flow conditions do not occur every day, or week, etc. The step of obtaining the free flow speed for an element may comprise analysing positional data relating to the movement of devices that traversed the element or portion thereof within a given predetermined time period, preferably wherein the free flow time obtained by averaging the speed of different devices traversing the element in the given time period.

The plurality of congestion hotspots that are generated by the present invention, in any of its aspects and embodiments, can be used in a number of ways. For example, the congestion hotspots can be shown to a user on a display device, optionally together with a visual representation of the electronic map. The congestion hotspots may be displayed to the user with different colours, or different visual effects, depending on the severity of the hotspot. The severity may be indicative of the amount of delay associated with the hotspot. For instance, in accordance with the first aspect, a first identified congestion hotspot having a first aggregated delay value may be displayed using a first colour (or other visual effect), and a second identified congestion hotspot having a second aggregated delay value is displayed using a second colour (or visual effect). In embodiments, the segments within the network may be divided into a number of equally sized buckets (each bucket containing approximately the same number of segments), with each bucket associated with a different colour or other visual effect, such that the segments within each hotspot are visualised using the colour or other visual effect associated with the respective bucket. It has been found that using this non-linear categorisation of the segments may provide a clearer visualisation of the hotspots.

The congestion hotspots can also be used by a route planning device when generating a route from an origin to a destination through the navigable network using the electronic map. For example, the segments forming the congestion hotspots can be blocked, or at least penalised, such that they are not considered, or at least avoided, when the route planning algorithm explores routes through the electronic map. This allows a user to be provided with a route that completely, or at least partially, avoids the congestion hotspots in a geographic area, and for which navigation instructions can be generated to guide the user along the generated route. In preferred embodiments, however, the congestion hotspots are provided to one or more road infrastructure controllers, or other similar professionals, for use in identifying problem areas of the road network in the geographic area, e.g. by being displayed via a web portal. For example, the geographic area could be predetermined and correspond to a particular city, such as London, Paris, Amsterdam, etc.; with congestion hotspots being generated for each city. It is also contemplated that the geographic area could be defined by a user, such that the method comprises receiving data indicative of a first geographic area from a user, and selecting a portion of an electronic map covering a larger second geographic area that relates to the received first geographic area for use in identifying congestion hot spots within the first geographic area.

Where congestion hotspots are generated by a server, the method may extend to the step of issuing data indicative of one or more of the congestion hotspots. The step of issuing the data involves making the data available, for example, to one or more devices, which may be client devices, and/or to another server (which may or may not be a client server). Issuing the data may involve transmitting data indicative of the one or more congestion hotspots to the or each device or server. The data may be transmitted directly or via one or more intermediate components, such as another server. A server may automatically cause the data to be transmitted to a device or server, or may cause the data to be transmitted in response to a request received from a device or server. Thus, making the data available may involve transmitting the data or making the data available for subsequent transmission, for example, to a device or server.

The data indicative of the one or more congestion hotspots may be issued to one or more devices, e.g. client devices. The or each device is preferably associated with a vehicle. The or each device may be a navigation device, such as a portable navigation device (PND) or integrated navigation device, and/or an automatic vehicle management system, e.g. an Advanced Driver Assistance System (ADAS) system associated with a vehicle. Alternatively or additionally, the step of issuing the data may comprise the server issuing the data to another server, e.g. via a communication network. The server may transmit data indicative of the data to the another server. The another server may then use the obtained data or not, depending upon its settings. The another server may in turn issue the data to one or more client devices associated with vehicles and in communication therewith. In these embodiments the another server may be arranged to receive data indicative of the one or more congestion hotspots, e.g. from one or more servers, and may select a subset of the data for issue to its client devices. The another server may be a server associated with an automobile manufacturer, navigation system provider, etc.

In any of the embodiments of the invention in which a server generates the data indicative of the one or more congestion hotspots, the server may broadcast the generated data. The data may be issued, i.e. output in any suitable manner to enable it to be used by any one of a plurality of servers and/or devices associated with vehicles, e.g. navigation devices and/or automatic vehicle control systems. This is in contrast to transmitting the data to a specific navigation device associated with a vehicle.

When data indicative of one or more congestion hotspots within a geographic area is received, e.g. by a device associated with a vehicle or a server, the data may or may not be used by the device or server depending upon the settings of the receiving device or server. For example, information about a congestion hotspot may only be output when a vehicle approaches, or is in the vicinity of, the congestion hotspot. Data indicative of a congestion hotspot may be output to a driver, and the method extends to such a step. The data may be output in any suitable manner, including visually, audibly and/or haptically. The data may be output by a navigation device.

Whether generated by a server or other computing device, data indicative of one or more congestion hotspots may be used in any suitable manner. Any of the steps described relating to the use of the data may be carried out by the same device or server that generated the data, or another server or device, e.g. that has received the generated data.

In embodiments of the invention, according to any of its aspects, and in particular in relation to embodiments wherein the congestion hotspots are provided to one or more road infrastructure controllers, the method may extend to ranking the determined congestion hotspots for the geographic area. In such embodiments, delay data is determined for each of the one or more paths in a hotspot using the positional data, wherein the delay data for a path is representative of a delay experienced due to congestion by the devices when traversing the navigable elements or portions thereof of the path. The delay data for a path is preferably determined using the delay data for the segments constituting the path. The delay data for the path can therefore be indicative of an average delay or an accumulate delay. The delay data for each of the paths in a congestion hotspot is preferably then used to determine delay data for each congestion hotspot, and each of the congestion hotspots within a geographic area preferably ranked according to the determined delay data. Accordingly, in embodiments, when congestion hotspots are displayed to a user, they can be displayed in an order based on the ranking and/or in combination with data indicative of the position of the congestion hotspot in the ranking.

The present invention also extends, in embodiments, to techniques for generating names for the identified congestion hotspots. It will be appreciated that such techniques may generally be applied to congestion hotspots however they are identified. Thus, although the techniques may preferably be used to generate names for congestion hotspots that have been identified using the methods described herein in relation to the present invention in any of its aspects or embodiments, the techniques for generating names are generally independent of the manner in which the congestion hotspot is identified. The names may suitably be generated in the form of an alphanumeric string. The names may be generated using road name data in combination with the determined delay data. For instance, the names may be generated from road name data that is stored in or accessible from the electronic map. By way of example, a name may be generated by grouping together the segments within each identified congestion hotspot based on said road name data to form a plurality of groups, each group representing a road; and determining a contribution, e.g. percentage, of each group to the aggregated delay of the congestion hotspot. A name may thus be generated using the road name data for the one or more groups having the greatest contribution. For example, the name of the congestion hotspot may be a concatenation of the names of the roads having the greatest contribution. Generating names in this way, using the road name data, has been found to help in making the congestion hotspots more human-relatable, as the hotspots are given names that users can readily recognise from the existing road names.

It will be appreciated that the methods in accordance with the present invention may be implemented at least partially using software. It will this be seen that, when viewed from further aspects, the present invention extends to a computer program product comprising computer readable instructions adapted to carry out any or all of the method described herein when executed on suitable data processing means. The invention also extends to a computer software carrier comprising such software. Such a software carrier could be a physical (or non-transitory) storage medium or could be a signal such as an electronic signal over wires, an optical signal or a radio signal such as to a satellite or the like.

The present invention in accordance with any of its further aspects or embodiments may include any of the features described in reference to other aspects or embodiments of the invention to the extent it is not mutually inconsistent therewith.

Any reference to comparing one item to another may involve comparing either item with the other item, and in any manner.

It should be noted that the phrase “associated therewith” in relation to one or more segments or elements should not be interpreted to require any particular restriction on data storage locations. The phrase only requires that the features are identifiably related to a segment or element. Therefore association may for example be achieved by means of a reference to a side file, potentially located in a remote server.

Advantages of these embodiments are set out hereafter, and further details and features of each of these embodiments are defined in the accompanying dependent claims and elsewhere in the following detailed description.

### BRIEF DESCRIPTION OF THE DRAWINGS

Various aspects of the teachings of the present invention, and arrangements embodying those teachings, will hereafter be described by way of illustrative example with reference to the accompanying drawings, in which:

FIG. 1 is a flow chart illustrating the steps of a method of identifying congestion hotspots in a navigable network within a geographic area in accordance with an embodiment of the invention;

FIG. 2 is a flow chart illustrating the steps of a method of identifying congestion hotspots in a navigable network within a geographic area in accordance with another embodiment of the invention;

FIG. 3 shows the top ten congestion hotspots for the morning rush hour in Amsterdam during the period April to June 2015;

FIG. 4 shows an enlarged view of the sixth most severe congestion hotspot for Amsterdam from FIG. 3;

FIG. 5 shows information about the congestion hotspot of FIG. 4;

FIG. 6 shows information about a segment of the congestion hotspot of FIG. 4; and

FIG. 7 is a flow chart illustrating the steps of a method for generating names for identified congestion hotspots.

### DETAILED DESCRIPTION OF THE PREFERRED EMBODIMENTS

The present invention is, in preferred embodiments at least, directed to methods and systems for identifying congestion hotspots in a road network within a geographic area. Typically the geographic area is representative of a city. Congestion hotspots identify the areas of worst traffic congestion in the city area as defined by causing the most significant delays to traffic. Calculations are typically made for a number of different time periods throughout the day, such as morning peak periods (e.g. from 06:00 to 10:00), afternoon peak periods (e.g. from 15:00 to 18:00), or for a typical working hours (e.g. from 06:00 to 18:00). As will be discussed below, the congestion hotspots are determined using positional data indicative of journeys made by devices carried by, or integrated in, vehicles along the road network, such as personal navigation devices, in-dash navigation systems, smartphones, fleet management devices, etc., and which is often referred to as floating car data (FCD).

The present invention may be implemented in relation to navigable elements of any type.

Preferably the navigable elements are road elements (of a road network). In some embodiments the navigable element(s) are elements of a highway, but it will be appreciated that the techniques are applicable to any type of road element, or indeed other type of navigable element, where appropriate positional data exists or can be determined. While exemplary embodiments refer to road elements of a road network, and these embodiments will now be described in further detail, it will be appreciated that the invention is applicable to any form of navigable element, including elements of a path, river, canal, cycle path, tow path, railway line, or the like. For ease of reference these are commonly referred to as a road element of a road network. The present invention is therefore applicable to detecting delays for any navigable element.

The steps of the method are preferably carried out by a server that has access to an electronic map representative of a road network within a geographic area indicative of a city. The electronic map comprises a plurality of segments that represent the road network. The method uses historic positional data, e.g. GPS probe data, that has been collected over an extended period of time, such as three months. The probe data is vehicle probe data received from devices associated with vehicles, e.g. GPS devices, whose position corresponds to that of the vehicle. The probe data may alternatively be referred to as “positional data”. The probe or positional data is associated with temporal data. The positional data may be matched to segments of the electronic map, and used to determine a number of attributes for each of the segments. For example, each segment is associated with one or more of the following attributes: segment identifier; length; geographic coordinates of the start and end of the segment; a number of hits, i.e. the number of vehicles traversing the road represented by the segment (for each of a number of recurring time periods, such as each weekday, and morning and/or afternoon peak periods for each day of the week); a free flow speed, i.e. the average speed of vehicles along the road represented by the segment when traffic is moving freely; and a congestion level, i.e. the ratio of free flow speed to the average speed of vehicles traversing the road represented by the segment (again for each of the number of recurring time periods).

The attributes associated with each segment is used in the exemplary method of the present invention to determine a delay value (generally, “delay data”) for the segment. The delay data is typically the accumulated delay per unit length, although other representations of delay can be used, such as the average delay per unit length. By using the accumulated delay per unit length, then the influence of segment length can be removed from the ranking step (as will be discussed in more detail below). The accumulated delay is determined by multiplying the average delay by the number of hits for the segment, or a weighting factor representative of the same. The average delay may generally be calculated as follows:

$$average delay = time ( average ) - time ( free flow ) = \frac{length}{speed ( average )} - \frac{length}{speed ( free flow )}$$

$$therefore , \\ average delay = \frac{length}{speed ( free flow )} * ( congestion - 1 )$$

$$congestion = \frac{speed ( free flow )}{speed ( average )}$$

The accumulated delay per segment may be determined from the average delay per vehicle and the trace count to the power of the traffic density, e.g. by:

accumulated delay=average delay*T^{td}

wherein T is the trace count (i.e. the number of probes that have been measured traversing the segment) and td is a number between 0 and 1 representative of the “traffic density” associated with the segment. Thus, it can be seen that the accumulated delay is effectively weighted according to the number of vehicles that have traversed the segment. This may help to identify segments where there is a high average delay, even if only a few drivers, and also where there is relatively little delay, but the delay is experienced by a large number of drivers, both of which may be considered as a congested hotspot.

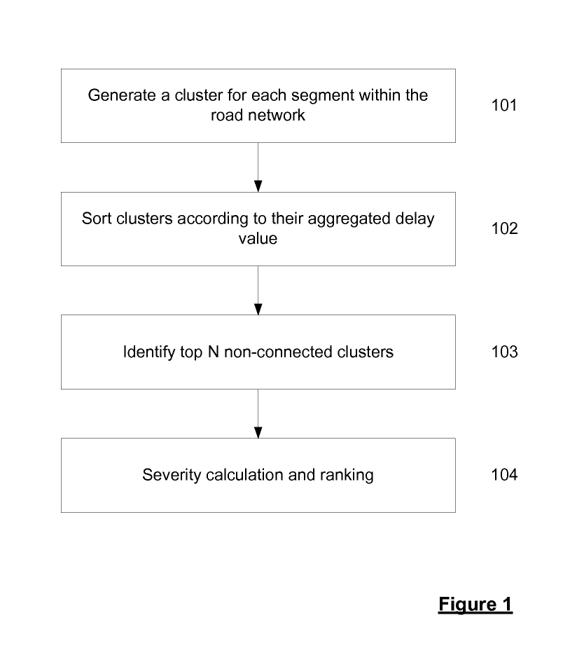

The delay data for the segments in the road network may then be processed in order to identify congestion hotspots in the road network. A first technique for identifying hotspots according to an embodiment of the invention is illustrated in FIG. 1.

In step 101, a cluster is generated for each segment in the network (or at least for each segment in the network for which there is sufficient probe data). The cluster creation algorithm works by expanding out from the initial segment in all directions and iteratively adding to the cluster all of the connected segments until the length of the road network covered by the cluster exceeds some defined threshold value. The threshold value may be defined at any suitable value depending on the desired cluster size and the attributes of the road network. For example, the threshold value may be set at about 1 km. A cluster is thus built around an initial segment by first adding into the cluster all segments that are connected to the initial segment (i.e. segments of one degree distance in the network from the initial segment). Next, segments of two degree distance (i.e. all segments that are connected to the segments connected to the initial segment added into the cluster during the first step), and three degree distance, and so on, are added into the cluster until the cluster reaches the desired size, L. This process is repeated for each segment in the network so that a cluster of approximate size L is generated for each segment. Naturally, the clusters generated at this stage will overlap with each other since they share segments.

In step 102, the generated clusters are sorted by their aggregate delay values from high to low. The aggregate delay value of a cluster may be calculated by summing (or otherwise combining) the delay values for each segment in the cluster.

In step 103, the list of sorted clusters are then processed, working from the highest aggregate delay value down to the lowest aggregate delay value, and clusters are added to a results list if they satisfy a certain condition. Particularly, a cluster is added to the results list provided that there is no connecting or overlapping cluster already in the results list. The list of sorted clusters may be processed in this way until a desired number of clusters, N, have been added to the results list. The results list thus contains a set of N clusters being the N non-connected (i.e. non-overlapping) clusters having the highest aggregate delay values. These clusters are thus identified as congestion hotspots. The value of N may be set as desired. By way of example, a typical value for N may be around 25.

Finally, in step 104, the congestion hotspots are each assigned a severity value (or, “delay score”). The severity value typically takes a number between 0 and 100; with the hotspot having the highest aggregate delay value being assigned a severity value of 100, and the other hotspots being assigned a severity value of less than 100 based on the ratio of the delay for the hotspot to the delay for the hotspot with the highest delay.

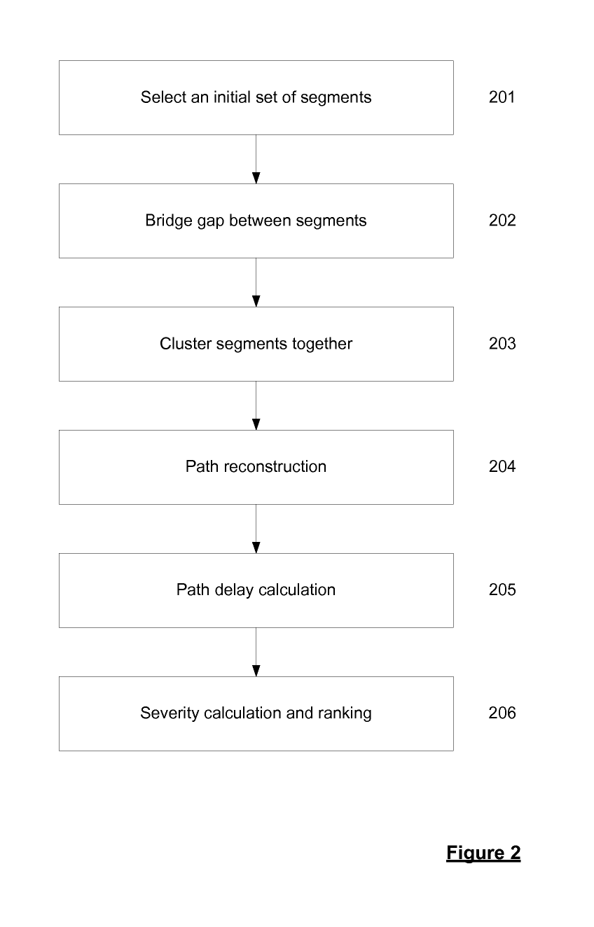

An alternative method of identifying congestion hotspots according to a second embodiment of the invention will now be described in relation to FIG. 2.

In step 201, a base set of segments are selected. The base set of segments are chosen by ranking the segments of the electronic map based on the delay data, and then selecting a predetermined number of segments having the highest accumulated delay per unit length.

In step 202, gaps are bridged between the segments of the base set of segments. The method attempts to find paths of reasonably high delay that connect the segments of the base set of segments. The segments of these paths are then added to the segments of the base set to determine a second set of segments. The method of bridging the gap involves finding the shortest paths between each pair of segments in the base set of segments. If a shortest path meets acceptance criteria based on delay and length, then the segments of the path are combined with the base set of segments.

In step 203, the segments of the second set are grouped together into clusters. This process involves including a segment S1 in a cluster C if there is some segment S2, where S2 ∈ C, such that S1 and S2 are neighbours in the road topology.

In step 204, paths are found through each of the clusters generated in step 3. The one or more paths that users of the road network are most likely to taken are chosen and these paths form a congestion hotspot. Accordingly, the number of congestion hotspots generated for a geographic area will equal the number of clusters that are formed. The paths through the cluster that users are most likely to take can be based on any information as desired, but typically comprises looking at the number of unique trips along each path taken by devices from which positional data is obtained.

In step 205, delay data, such as an accumulated delay, is determined for each path in each congestion hotspot.

Finally, in step 206, the delay data for each path within a congestion hotspot is used to determine a severity value for each hotspot, similarly as in the method described above.

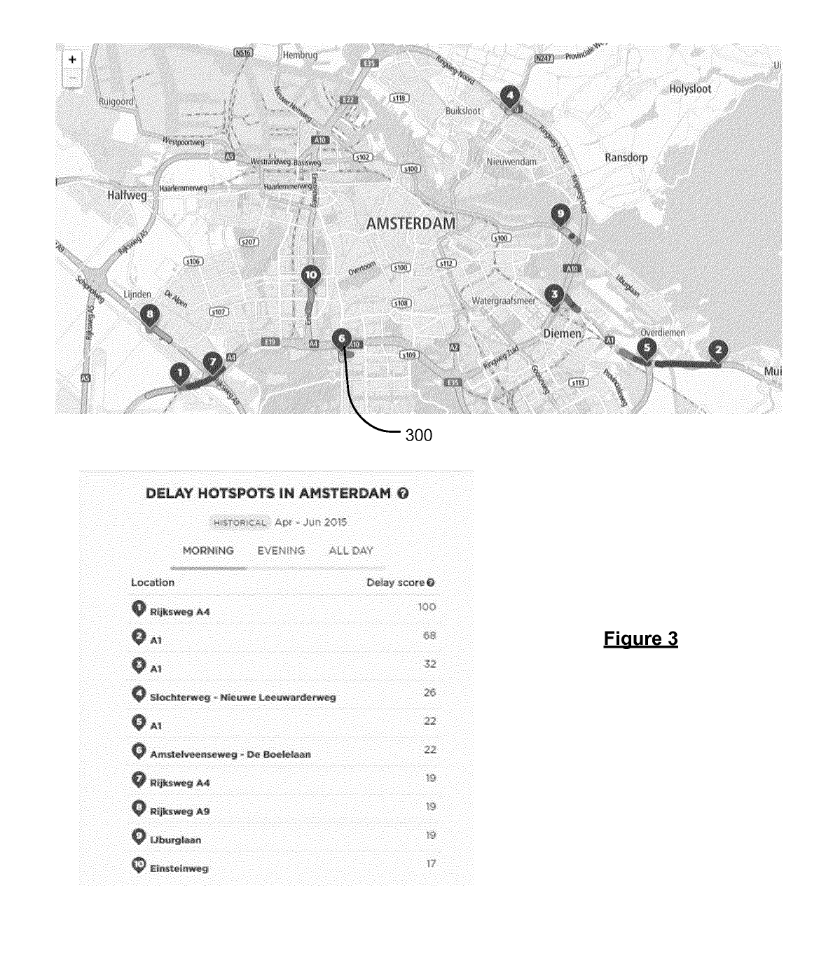

However they are determined, e.g. according to either of the methods described above, the hotspots for the geographic area, e.g. city, may then be ranked based on the determined severity value and can be displayed to a user, e.g. as shown in FIGS. 3 to 6.

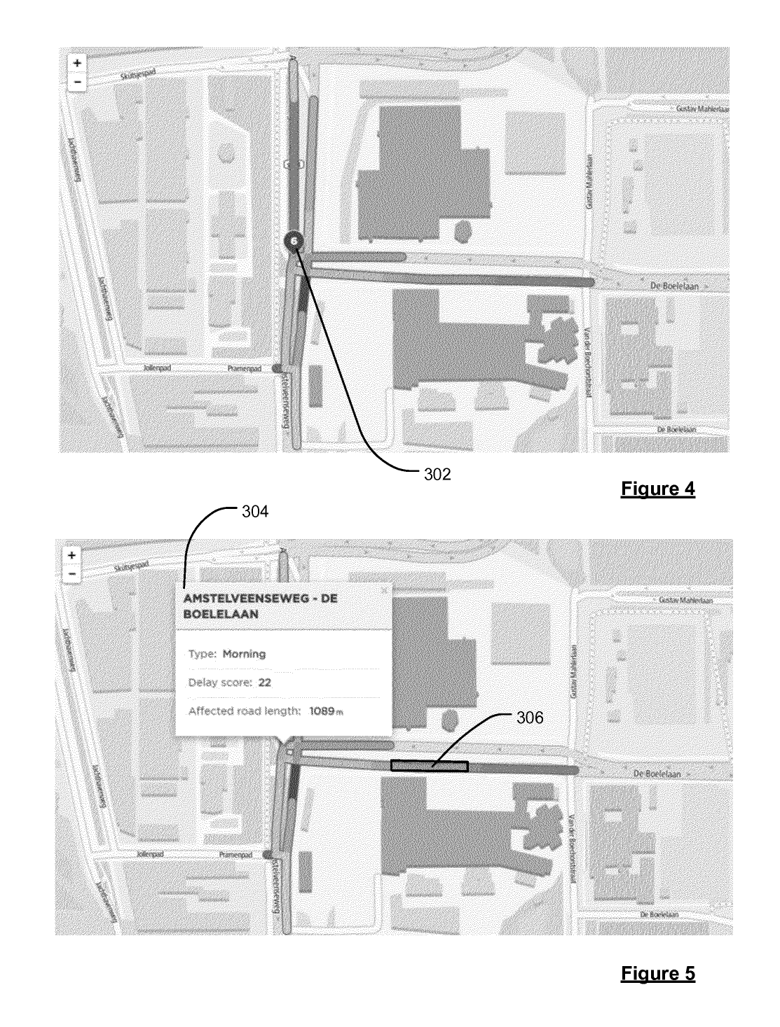

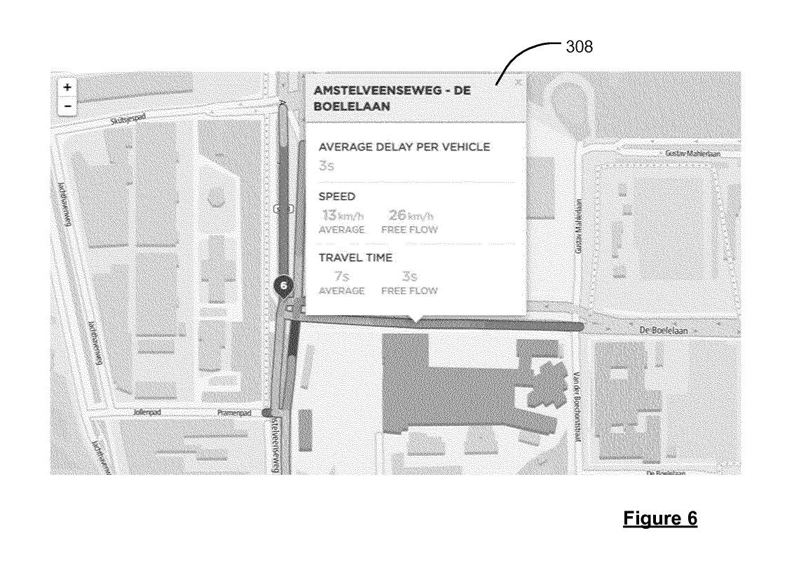

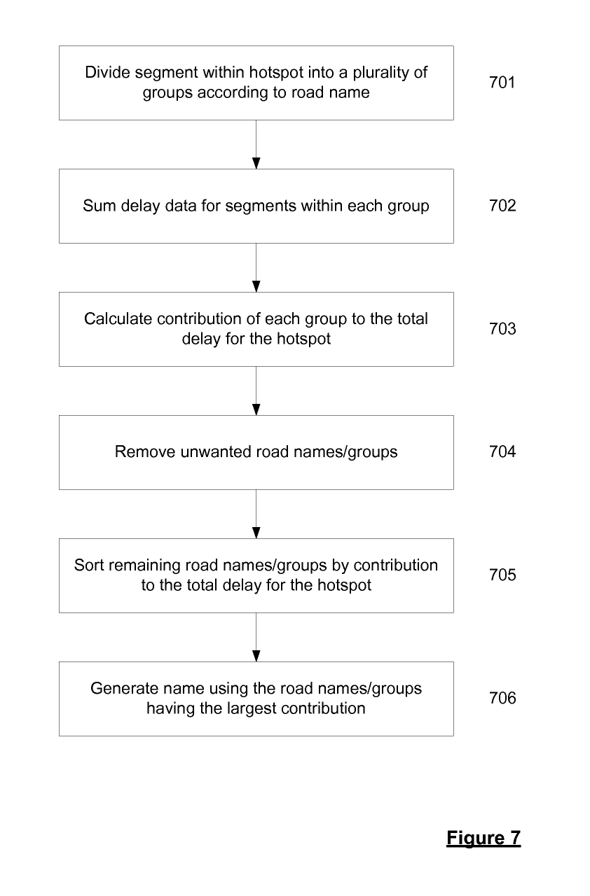

FIG. 3 shows a map of Amsterdam including the road network in the city, together with the 10 most severe hotspots as determined by a method in accordance with the present invention for the morning peak period (or rush hour) based on data for the period April to June 2015. This data can be made available to users via a web portal, such that a user can see the data on any connected computing device. As an example, the sixth most severe hotspot is that at “Amstelveenseweg—De Boelelaan” and has a severity value (or “delay score”) of 22 relative to the most severe hotspot that can be found at “Rijksweg A4”. The icon representative of the sixth most severe hotspot—denoted as 300—can be selected by the user to provide a more detailed visualisation of the hotspot, which can be seen in FIG. 4, and which shows the relative severity of the delay for each of the segments of the electronic map. The user can again select the icon representative of the hotspot—denoted as 302—so as to show additional details about the segment, such the total length of the hotspot, as illustrated in FIG. 5—denoted as 304. A user is further able to select each individual segment of the hotspot, e.g. in this case the user has selected the segment denoted as 306, to show more details about the delays for each segment. This is shown in FIG. 6, where the details about the segment are denoted as 308, and include information such as: the average delay; the average speed and travel time; and the free flow speed and travel time for the selected segment 306.

The geometry of the identified hotspots may be visualised by colouring the segments within the hotspot based on the delay data. For example, in preferred embodiments, all of the segments within the road network are initially divided according to their associated delay data into a number of buckets (e.g. 5) of approximately equal size such that each bucket contains approximately the same number of segments. Each bucket is then assigned a colour value, e.g. progressing from low to high delay from yellow to red, or some other suitable visual indication, so that all of the segments within a particular bucket are visualised in the same way. Thus, when a hotspot is identified, the segments in the hotspot may be coloured according to the respective bucket. It has been found that using this non-linear categorisation for visualising segments may be more advantageous than a linear colour gradient, for instance, because the least delayed segments in a hotspot tend to far outnumber the most delayed segments, and so if a linear gradient was used, the majority of segments would have roughly the same colour and it may be less easy for a user to visually differentiate between segments. However, it will be appreciated that the hotspots may be visualised in various suitable ways, including using a linear gradient based on the accumulated delay values, and that the non-linear categorisation described above is merely one exemplary, albeit preferred, technique.

The invention also extends to methods of generating human-relatable, or recognisable, names for the identified congestion hotspots. Thus, once a congestion hotspot has been identified, e.g. by the methods illustrated in either of FIG. 1 or FIG. 2, a name may be generated. FIG. 7 illustrates an exemplary algorithm for generating a name for an identified congestion hotspot.

In step 701, the segments within the identified congestion hotspot are grouped together by road name, as may be determined from road name data stored in or with the electronic map data. Thus, the congestion hotspot is decomposed into its constituent set of real roads (or portions of roads) within the road network.

In step 702, the delay data or delay values for the segments within each group are summed together, and this is used, in step 703, to calculate the delay contribution of each road in the congestion hotspot.

A filtering may optionally be performed in step 704 in order to remove any unwanted or low contribution roads. For instance, this may include filtering out all road names that contribute less delay than a certain pre-defined threshold value (e.g. 10% of the aggregate delay for the congestion hotspot). Furthermore, this may include filtering out any roads where the real road names are not known or undesired.

In step 705, the remaining road names are sorted in descending order according to their contribution, and the top M road names are selected, wherein M is an integer value that may be set as desired.

In step 706, the selected M road names are used to build an alphanumeric string giving the name for the hotspot. For instance, the name may comprise the M road names joined by a separator such as a “/” or “-” character. In general, the value of M may be set as desired. For example, where the value of M is set to 1, the congestion hotspot will be named after the road segment that contributes the largest delay. Similarly, where the value of M is set to 2, the congestion hotspot will be named after the two road segments contributing the largest delays (e.g. as for the congestion hotspot “Amstelveenseweg—De Boelelaan” identified in FIG. 5). The value of M will typically be set at, or at least no higher than, 3 to avoid generating overly convoluted names.

Although the present invention has been described with reference to preferred embodiments, it will be understood by those skilled in the art that various changes in form and detail may be made without departing from the scope of the invention as set forth in the accompanying claims.

Finally, it should be noted that whilst the accompanying claims set out particular combinations of features described herein, the scope of the present invention is not limited to the particular combinations of hereafter claims, but instead extends to encompass any combination of features or embodiments herein disclosed irrespective of whether or not that particular combination has been specifically enumerated in the accompanying claims at this time.

1. A method of identifying congestion hotspots in a navigable network within a geographic area, each navigable element being represented by one or more segments of an electronic map, the electronic map comprising a plurality of segments representative of the navigable network, each segment being connected to at least one other segment, said method comprising:
obtaining positional data relating to the movement of a plurality of devices with time along navigable elements represented by segments of the electronic map;
determining, using the positional data, delay data for at least one time period associated with each of a plurality of the segments, wherein the delay data for a segment is representative of a delay experienced due to congestion by the devices when traversing the navigable element or portion thereof represented by the segment during the respective time period;
generating a plurality of clusters from at least the plurality of segments having delay data, wherein each cluster comprises a plurality of segments, and wherein each segment in a cluster is connected to at least one other segment in the cluster;
determining an aggregated delay value for each generated cluster, wherein the aggregated delay value for a cluster is obtained using delay data associated with segments in the cluster; and
identifying one or more of said plurality of clusters as congestion hotspots based on said aggregated delay values.

2. The method of claim 1, comprising sorting the plurality of clusters according to the determined aggregated delay values.

3. The method of claim 1, comprising identifying as a congestion hotspot the cluster(s) having the highest aggregated delay value.

4. The method of claim 1, comprising selecting a set of N non-connected clusters having the highest aggregated delay values, and identifying the selected set of N non-connected clusters as congestion hotspots, wherein N is a desired number of congestion hotspots to be identified.

5. The method of claim 1, wherein a cluster is generated by selecting an initial segment, and iteratively adding to the cluster all segments in the network that are connected to at least one segment in the cluster until the length of the navigable network covered by the cluster satisfies a defined threshold condition.

6. The method of claim 1, wherein a cluster is generated for each segment within the navigable network.

7. A method of identifying congestion hotspots in a navigable network within a geographic area, each navigable element being represented by one or more segments of an electronic map, the electronic map comprising a plurality of segments representative of the navigable network, each segment being connected to at least one other segment, said method comprising:
obtaining positional data relating to the movement of a plurality of devices with time along navigable elements represented by segments of the electronic map;
determining, using the positional data, delay data for at least one time period for each of a plurality of the segments, wherein the delay data for a segment is representative of a delay experienced due to congestion by the devices when traversing the navigable element or portion thereof represented by the segment during the respective time period;
identifying, using the determined delay data, a subset of segments from the plurality of segments that form paths through the navigable network represented by the electronic map having high delay;
determining a plurality of clusters from the subset of segments, wherein each cluster comprises a plurality of segments, and wherein each segment in a cluster is connected to at least one other segment in the cluster; and
selecting, using the positional data, one or more paths though each cluster that are most frequently traversed by devices to determine a congestion hotspot for each of the clusters, wherein the congestion hotspot for a cluster comprises the selected one or more paths for the cluster.

8. The method of claim 7, wherein said delay data comprise accumulated delay data obtained by multiplying the average delay experienced by a plurality of devices traversing the segment by a weighting factor indicative of the number of devices that traversed the segment.

9. The method of claim 7, comprising ranking the identified congestion hotspots according to severity, wherein the severity is determined using the delay data, and displaying the identified congestion hotspots to a user such that a first congestion hotspot having a first severity value is displayed using a first colour, or other visual effect, and a second congestion hotspot having a second severity value is displayed using a second colour or visual effect.

10. The method of claim 7, comprising identifying a plurality of congestion hotspots in the navigable network for a plurality of different time periods.

11. The method of claim 7, wherein said navigable elements are roads, the method comprising generating a name for each identified congestion hotspot using road name data obtained or obtainable from said electronic map and the determined delay data for the segments within each identified congestion hotspot, wherein said name comprises an alphanumeric string.

12. The method of claim 11, comprising grouping together segments within each identified congestion hotspot based on said road name data to form a plurality of groups, each group representing a road; determining a contribution of each group to the aggregated delay of the congestion hotspot; and generating said name using the road name data for the one or more groups having the greatest contribution.

13. A system for identifying congestion hotspots in a navigable network within a geographic area, each navigable element being represented by one or more segments of an electronic map, the electronic map comprising a plurality of segments representative of the navigable network, each segment being connected to at least one other segment, said system being constructed and arranged to:
obtain positional data relating to the movement of a plurality of devices with time along navigable elements represented by segments of the electronic map;
determine, using the positional data, delay data for at least one time period associated with each of a plurality of the segments, wherein the delay data for a segment is representative of a delay experienced due to congestion by the devices when traversing the navigable element or portion thereof represented by the segment during the respective time period;
generate a plurality of clusters from at least the plurality of segments having delay data, wherein each cluster comprises a plurality of segments, and wherein each segment in a cluster is connected to at least one other segment in the cluster;
determine an aggregated delay value for each generated cluster, wherein the aggregated delay value for a cluster is obtained using delay data associated with segments in the cluster; and
identify one or more of said plurality of clusters as congestion hotspots based on said aggregated delay values.

14. A system for identifying congestion hotspots in a navigable network within a geographic area, each navigable element being represented by one or more segments of an electronic map, the electronic map comprising a plurality of segments representative of the navigable network, each segment being connected to at least one other segment, said system being constructed and arranged to:
obtain positional data relating to the movement of a plurality of devices with time along navigable elements represented by segments of the electronic map;
determine, using the positional data, delay data for at least one time period for each of a plurality of the segments, wherein the delay data for a segment is representative of a delay experienced due to congestion by the devices when traversing the navigable element or portion thereof represented by the segment during the respective time period;
identify, using the determined delay data, a subset of segments from the plurality of segments that form paths through the navigable network represented by the electronic map having high delay;
determine a plurality of clusters from the subset of segments, wherein each cluster comprises a plurality of segments, and wherein each segment in a cluster is connected to at least one other segment in the cluster; and
select, using the positional data, one or more paths though each cluster that are most frequently traversed by devices to determine a congestion hotspot for each of the clusters, wherein the congestion hotspot for a cluster comprises the selected one or more paths for the cluster.

15. A non-transitory computer readable medium comprising computer readable instructions that, when executed by a system comprising one or more processors, cause the system to perform a method of identifying congestion hotspots in a navigable network within a geographic area, each navigable element being represented by one or more segments of an electronic map, the electronic map comprising a plurality of segments representative of the navigable network, each segment being connected to at least one other segment, said method comprising:
obtaining positional data relating to the movement of a plurality of devices with time along navigable elements represented by segments of the electronic map;
determining, using the positional data, delay data for at least one time period associated with each of a plurality of the segments, wherein the delay data for a segment is representative of a delay experienced due to congestion by the devices when traversing the navigable element or portion thereof represented by the segment during the respective time period;
generating a plurality of clusters from at least the plurality of segments having delay data, wherein each cluster comprises a plurality of segments, and wherein each segment in a cluster is connected to at least one other segment in the cluster;
determining an aggregated delay value for each generated cluster, wherein the aggregated delay value for a cluster is obtained using delay data associated with segments in the cluster; and
identifying one or more of said plurality of clusters as congestion hotspots based on said aggregated delay values.

16. A non-transitory computer readable medium comprising computer readable instructions that, when executed by a system comprising one or more processors, cause the system to perform a method of identifying congestion hotspots in a navigable network within a geographic area, each navigable element being represented by one or more segments of an electronic map, the electronic map comprising a plurality of segments representative of the navigable network, each segment being connected to at least one other segment, said method comprising:
obtaining positional data relating to the movement of a plurality of devices with time along navigable elements represented by segments of the electronic map;
determining, using the positional data, delay data for at least one time period for each of a plurality of the segments, wherein the delay data for a segment is representative of a delay experienced due to congestion by the devices when traversing the navigable element or portion thereof represented by the segment during the respective time period;
identifying, using the determined delay data, a subset of segments from the plurality of segments that form paths through the navigable network represented by the electronic map having high delay;
determining a plurality of clusters from the subset of segments, wherein each cluster comprises a plurality of segments, and wherein each segment in a cluster is connected to at least one other segment in the cluster; and
selecting, using the positional data, one or more paths though each cluster that are most frequently traversed by devices to determine a congestion hotspot for each of the clusters, wherein the congestion hotspot for a cluster comprises the selected one or more paths for the cluster.

17. The method of claim 1, wherein said delay data comprise accumulated delay data obtained by multiplying the average delay experienced by a plurality of devices traversing the segment by a weighting factor indicative of the number of devices that traversed the segment.

18. The method of claim 1, comprising ranking the identified congestion hotspots according to severity, wherein the severity is determined using the delay data, and displaying the identified congestion hotspots to a user such that a first congestion hotspot having a first severity value is displayed using a first colour, or other visual effect, and a second congestion hotspot having a second severity value is displayed using a second colour or visual effect.

19. The method of claim 1, comprising identifying a plurality of congestion hotspots in the navigable network for a plurality of different time periods.

20. The method of claim 1, wherein said navigable elements are roads, the method comprising generating a name for each identified congestion hotspot using road name data obtained or obtainable from said electronic map and the determined delay data for the segments within each identified congestion hotspot, wherein said name comprises an alphanumeric string.
